(19) United States
(12) Patent Application Publication
(10) Pub. No.: US 2020/0008436 A1
(43) Pub. Date: Jan. 9, 2020

(54) COMPOSITION FOR CONTROLLING SUPERFICIAL SCALD IN POME FRUIT

(71) Applicant: UNIVERSIDAD DE TALCA, Talca (CL)

(72) Inventor: Carolina Andrea TORRES DEL CAMPO, Talca (CL)

(21) Appl. No.: 16/490,046

(22) PCT Filed: Mar. 8, 2017
(86) PCT No.: PCT/CL17/50010

§ 371 Date: Aug. 29, 2019

(51) Int. Cl. A23B 7/16; A23B 7/154

(52) U.S. Cl. CPC A23B 7/16; A23V 2002/00; A23B 7/154

(57) ABSTRACT

The present invention relates to a novel composition and a method for preserving pome fruits, specifically for controlling scald caused by cold damage, based on the use of squalene of plant origin as an active ingredient.

### TECHNICAL FIELD

The present invention is related to the technical field of food industries and with products for food preservation; and particularly discloses a new composition for the preservation of pome fruits.

### BACKGROUND

The superficial scald is a physiological disorder caused by cold stress to which fruits are subjected after being harvested, as part of the storage for prolonged periods of time longer than three months. Scald is characterized for producing necrotic lesions on the skin of fruits, which appear during shelf-life after cold storage, generating dark spots that alter their outer appearance. The above causes that the product is not chosen by consumers since it is not visually appealing, losing its commercial value.

Superficial scald is one of the most damaging physiological disorders in pome fruits of prolonged storage, since it causes irreversible damages and limits their prolonged cold storage. Apple varieties such as Granny Smith, Fuji and Red Delicious and pear varieties such as Packham's Triumph, Anjou and Barlett are the most affected cultivars. In Chile, Granny Smith variety is undoubtedly the most susceptible to scald and the cultivar with the highest impairments at commercial levels (Torres C., Hernández O., Fuentes M. (2012). Escaldado superficial en manzanas: nuevos desafíos. Pomáceas, Boletín Técnico, Volumen 12, número 1). Another variety that is affected is Law Rome (Mditshwa, A. y cols. (2016). Classification of ‘Granny Smith’ apples with different levels of superficial scald severity based on targeted metabolites and discriminant analysis. Journal of Applied Botany and Food Quality, 89).

In apples, the oxidative damage is superficial, manifesting itself as brownish spots on the skin, which generally does not affect fruit flesh. Damage is attributed to oxidation of sesquiterpenes, volatile compounds present in apple wax. During the period of cold storage α-farnesene accumulates, being subsequently oxidized, generating toxic substances such as conjugated trienes which are responsible for symptoms of superficial scald.

In pears, scald appears in two forms: superficial and senescent. In the first one, unlike in apples, harvest time does not affect the level of incidence. On the other hand, senescent scald symptomatology is similar to that of superficial scald, however it may compromise fruit flesh and is manifested in pears stored for more than 6 to 7 months in cold conditions (Torres C., Hernández O., Fuentes M. (2012). Escaldado superficial en manzanas: nuevos desafios. Pomáceas, Boletín Técnico, Volumen 12, número 1).

To prevent superficial scald different chemical compounds for application in fruits have been utilized, which affect their quality or prevent maturation. Diphenylamine (DPA) is a chemical compound that is applied in fruits after harvest for scald control in apples and pears (patent U.S. Pat. No. 3,526,519). During the last years the European regulatory authority (EFSA, European Food Safety Authority) has severely questioned the safety of this chemical compound in fruits, indicating that current studies are not sufficient to certify the security of its use. The main concern of said authority is the fact that due to degradation of diphenylamine there is production of nitrosamines, a family of potent carcinogen compounds that contaminate fruits (EFSA (2012). Conclusion on the peer review of the pesticide risk assessment of the active substance diphenylamine. European Food Safety Authority, EFSA Journal 10(1):2486-2527). Therefore, since year 2012 EFSA prohibited the use of DPA in apples and pears in Europe, reducing the allowable limit to 0.1 parts per million in imported fruits (EC (2013). European Commission Regulation No 772/2012, 8 Aug. 2013, amending Annexes II, III and V to Regulation (EC) No 396/2005 of the European Parliament and of the Council as regards maximum residue levels for diphenylamine in or on certain products. Official Journal of the European Union. L 217/2).

Another chemical compound widely used as anti-scalding agent is ethoxyquin, which is mainly used in pears. However, health authority of European Commission in 2011 determined that data known about this substance are still insufficient to conclude that it is safe for environment and for humans. Therefore, ethoxyquin became an active compound not permitted to elaborate phytosanitary products (Commission Decision 2011/143/EU of 3 Mar. 2011 concerning the non-inclusion of ethoxyquin in Annex I to Council Directive 91/414/EEC and amending Commission Decision 2008/941/EC) [notified with number C(2011) 1265]).

A third chemical compound used for the treatment of superficial scald in pears is 1-methylcyclopropene (1-MCP). Even though this compound may be a substitute for DPA or ethoxyquin, its effectiveness has not been completely demonstrated, and it has the additional disadvantage of producing the complete inhibition of pear maturation after harvest during cold storage. The above keeps pears hard, preventing them from reaching the quality required to consumption (Chiriboga Varea, M. D. L. Á. (2012). Universidad de Lleida, España. Aspectos bioquímicos del bloqueo de la maduración de peras ‘Conference’ tratadas con 1-metilciclopropeno (1-MCP) y aplicación de sistemas de control. Capítulo 5.1. Escaldado superficial).

The estate of the art also discloses compositions to control fruit scald whose active ingredients are terpenic compounds. Squalene is a triterpenic compound containing 30 carbon atoms (C₃₀H₅₀) which possess an important role as a precursor of sterols and is produced by a wide range of organisms from bacteria to human beings. This compound has been used as a natural antioxidant and in pharmaceutical industry. The main source for obtaining squalene is from an animal origin, specifically shark liver oil, however, current concerns about environment and conservation of marine species motivate the search of new alternative sources of squalene (Spanova, M., & Daum, G. (2011). Squalene-biochemistry, molecular biology, process biotechnology, and applications. European Journal of Lipid Science and Technology, 113(11), 1299-1320).

The publication of Nordby, H. E., & McDonald, R. E. (1990). Squalene applied to grapefruit prevents chilling injury. HortScience, 25(9), 1094, describes a composition in aerosol to prevent chilling injury in citric fruits, specifically grapefruits, consisting in squalene in a concentration between 5-10% dissolved in hexane. Treated fruits were stored at 5° C. during four weeks and a reduction of 69-80% in incidence of chilling injury was observed on them.

Squalane (IUPAC name 2,6,10,15,19,23-hexamethyltetracosane) is an organic triterpenic compound with a chemical formula of C₃₀H₆₂ that possess different properties. It is a colorless, odorless and tasteless hydrocarbonated oil having a high physical and chemical stability and an elevated resistance to chemical oxidation. Squalane is a product naturally produced in small quantities in skin and it is an important component of sebum, it helps to maintain the skin moisturised. For this reason, squalane has been extensively used as an important ingredient in cosmetic industry (Camin, F. y cols. (2010). Stable isotope ratios of carbon and hydrogen to distinguish olive oil from shark squalene-squalane. Rapid communications in mass spectrometry, 24(12), 1810-1816).

Traditionally, squalane is produced from catalytic hydrogenation of squalene. Since squalene in its chemical structure possess numerous double bonds between carbon atoms, when it enters in contact with air is oxidised and produces compounds with undesired properties. By contrast, squalane does not have double bonds in its chemical structure, which makes it more stable in comparison with squalene (Brunner, G. y cols. (2009). Phase Equilibrium of Hydrogen, Carbon Dioxide, Squalene, and Squalane. Journal of Chemical & Engineering Data, 54(5), 1598-1609). FIG. 1 shows the chemical structures of squalene and squalane.

Depending upon the source where squalene is obtained as raw material to produce squalane, the derived product will have different types of impurities. According to the publication McPhee, D. y cols. (2014). Squalane from Sugarcane. Cosmetics & Toiletries magazine, Vol. 129, No. 6, even squalane of 100% purity contains impurities. Squalene of animal origin obtained from shark liver contains environmental pollutants such as polychlorinated biphenyls (PCBs), dioxins and heavy metals that accumulate in the liver, which remain after obtaining squalane. By contrast, squalane obtained from squalene from raw materials of plant origin, particularly olive oil and sugar cane does not contain these contaminants, instead it includes molecules such as phytosterol esters and waxes of hydrocarbon long chain.

U.S. Pat. No. 4,921,715 describes a method to protect citric fruits from chilling injury, comprising the application of a medium containing squalene or a derived compound such as squalane (Sigma Chemical Company). Said document describes that in an experimental assay, when these compounds are applied on citric fruits they are effective in reducing chilling injury, allowing them to be stored at low temperatures for a prolonged period. Particularly, the document describes an experiment where grapefruit was sprayed with Triton X-100 supplemented with squalane 1% or squalene 0.25% and then the fruit was stored at 40° F. (approximately 4.4 ° C.) during 3 to 5 weeks. It was found that application of these solutions to citric fruits significantly increased resistance to chilling injury.

U.S. Pat. No. 5,376,391 describes a method and a composition to improve stability of fruits, vegetables or fungi, comprising at least one polysaccharide polymer, a preservant and a preservative agent and an acidifier. As a general disclosure, it indicates that the composition may optionally include an agent used for prevent from chilling injury, such as squalene.

As a consequence, there is still a lack of an optimized solution to address the problem of superficial scald in apples and pears, which allows to protect them for long periods and at the same time maintaining fruit quality.

### SUMMARY OF INVENTION

The present invention provides a composition for the control of scald in pome fruits, comprising squalane of plant origin and an appropriate vehicle. Preferably, pome fruits are apples and pears. In a preferred embodiment, the squalane of plant origin has a concentration in a range between 0.1-100% v/v, which is obtained from olive oil, and preferentially it is hydrogenated squalene from olive oil.

Regarding the appropriate vehicle of the composition of the present invention, preferably it is an emulsifying agent in a concentration range of 0.1-99.9% v/v of the composition. In a preferred embodiment, said emulsifying agent is selected from the group consisting of: oleic acid, palm fatty acid, a sorbitan ester or a primary alcohol. Additionally, the composition comprises ammonia in a range from 0.05-10% v/v.

Another object of invention of the present application is a method to control scalding in pome fruits, comprising the steps of providing a composition for the control of scald in pome fruits comprising squalane of plant origin and an appropriate vehicle; and contacting said composition with the surface of pome fruits. Said contact is preferably performed by immersion, nebulization or spray for at least one second.

Finally, the present invention describes the use of squalane of plant origin to manufacture a composition for controlling superficial scald in pome fruits.

### BRIEF DESCRIPTION OF THE DRAWINGS

FIG. 1 describes the chemical structures of squalene and squalane.

FIG. 2 describes the effect of application of squalane and squalene of animal origin on the surface of Granny Smith apples and the evaluation of incidence in superficial scald (SS).

FIG. 3 shows the reduction of the incidence in superficial scald in Granny Smith apples when treated with different prototypes of emulsions whose active ingredient is squalane from plant origin.

FIG. 4 shows the reduction on the incidence in superficial scald in Packham's Triumph pears in three commercial crops (A and B) when treated with an emulsion whose active ingredient is squalane from plant origin.

FIG. 5 shows the reduction of the presence of conjugated trienes in Granny Smith apples treated with emulsions of squalane of plant origin.

FIG. 6A shows the quantitation of firmness of the flesh in Granny Smith apples after application of an emulsion comprising squalane of plant origin. FIG. 6B shows a graph representing the skin color of Packham's Triumph pears after application of an emulsion comprising squalane of plant origin.

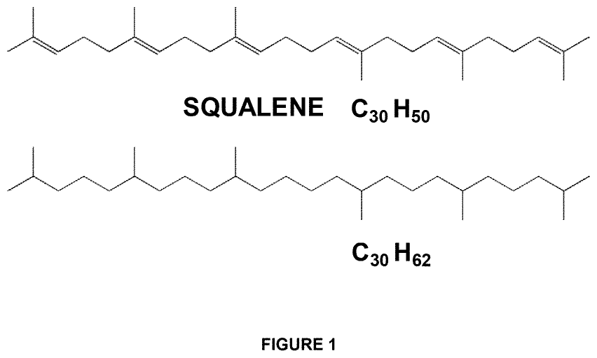

### DETAILED DESCRIPTION OF THE INVENTION

The present invention provides an anti-scald composition for pome fruits, comprising squalane of plant origin as active ingredient and an appropriate emulsifying agent. The invention also refers to a method for controlling scald in said fruits, comprising the application of the composition based on squalane of plant origin to the surface of the fruits. In this way, it is avoided the physiological disorder that affects fruits when stored in cold conditions and controlled atmosphere to preserve them for long periods. This phenomenon is mainly manifested as dark spots on the surface or skin of fruits, which then can spread to the fruit flesh.

In the present invention, squalane of plant origin, also named phyto-squalane, is used as active ingredient or principle in an anti-scald composition for pome fruits.

The composition may be applied on the surface of any pome fruit. The term “pome” or “pomaceous” should be understood as those fruits of pome type from the family of Rosaceae, such as apples, pears, quinces, medlars, loquats, among others, including all species, hybrids and existing varieties. In a preferred embodiment, apples belong to varieties Granny Smith, Golden Delicious, Gala, Fuji, Braeburn, Pink Lady, Rome Beauty, Stayman, Turley and Cortland. In another preferred embodiment, pears belong to varieties Packham's Triumph, Beurré D'Anjou, Red Anjou and Conférence. In another preferred embodiment, quinces belong to varieties Champion, Common and Wranja. In another favored embodiment, medlars belong to varieties Argelino, Tanaka and Golden Nugget.

Squalane used as active ingredient for controlling superficial scald in pome fruits of the present invention can be obtained from any raw material of plant origin, such as plant oils of olive, rice, palm, amaranth; or sugars or cellulosic biomass derived from plants such as sugar cane. Due to the plant origin of the raw material to obtain squalane is that the latter is named “squalane of plant origin or phyto-squalane”. These raw materials may be then treated by different processes for obtaining squalane. In a preferred embodiment of the present invention, squalane of plant origin is obtained from hydrogenation of squalene originated from olive oil. An example of said procedure to obtain squalane is specified in patent document ES 8,701,701, which comprises hydrogenation of subproducts from refinated olive oil, and in the publication Ciriminna R. y cols. (2014). Catalytic Hydrogenation of Squalene to Squalane. Organic Process Research & Development, 18(9), 1110-1115.

In another preferred embodiment, raw material is obtained from sugars of plants that are fermented to obtain farnesene, which is then dimerised and hydrogenated to obtain squalane (F. Laserson (2013). Neossance, 3rd generation squalane. Expression Cosmétique, AZ Guide of Cosmetic Ingredients, pp 325-328).

The composition for controlling scald or “anti-scald” in pome fruits which comprises squalane of plant origin as active ingredient additionally comprises an appropriate vehicle. Said vehicle is an emulsifying, emulgent, surfactant agent or any other useful for making fat miscible in aqueous solution and for obtaining an emulsion. The emulsifying agent is selected from the group consisting of a fatty acid, a sorbitan ester or a primary alcohol. In a preferred embodiment of the invention, squalane of plant origin is in a concentration between 20-100% v/v. Optionally, the composition may comprise a stabilizing agent or a pH regulator agent (between 8-11). The composition may have a liquid, gaseous, spray, gelatin or powder form.

The present invention also provides particular formulations whose active ingredient is squalane from plant origin and emulsifying agents selected after rigorous experimentation to find those able to provide an adequate emulsion. In a realization of the invention, an initial emulsion of concentrated squalane of plant origin is prepared with the emulsifying agents and then, at the moment of utilization, it is diluted in an aqueous solution before application in fruits.

In a preferred embodiment, a formulation of the present invention comprises an emulsion of squalane of plant origin 70% v/v, oleic acid 20% v/v, ammonia 4% v/v and deionized water 6% v/v. In another preferred embodiment, the formulation comprises an emulsion of squalane of plant origin 70% v/v, palm fatty acid 20% v/v, ammonia and water as previously mentioned.

In a third preferred embodiment, the formulation comprises squalane of plant origin 70% v/v and a surfactant primary alcohol having 9 to 15 carbon atoms, preferably a primary alcohol with 12 to 14 carbon atoms ethoxylated with ethylene oxide, such as Neodol® 30% v/v. In a fourth preferred embodiment, the formulation comprises squalane of plant origin 70% v/v and a sorbitan ester 30% v/v, preferably polyoxyethylenesorbitan monolaurate (Tween®-21). When application to fruits, the different emulsions, according to the preferred embodiments mentioned, are diluted to 0.1-10% v/v in aqueous solution before being applied on fruits. Preferentially, dilution range is 1-5% v/v in water.

The present invention also provides a method to control scald in pome fruits, comprising the steps of providing a composition whose active principle is squalane of plant origin and an appropriate vehicle, as previously mentioned, and applying it in such a way of contacting it with the surface of pome fruits. The application may be performed topically through immersion, nebulization or spray, or any other form that allows the contact of the composition with the surface of fruits during at least one second of time. In a preferred embodiment, the composition is applied by immersion or submerging the fruits in the same, during a period of one minute. In another preferred embodiment, the composition is applied after fruits are harvested, during a period not longer than 24 hours post-harvest. The application must be performed before storage in cold conditions.

The anti-scald composition of the present invention for controlling surface scald produced by cold in pome fruits has various advantages. The first one is having an anti-scald activity higher than 90% in apples and higher than 98% in pears. The fact that squalane is obtained from plant raw materials makes it suitable for commercialization as sustainable and eco-friendly organic products. Squalane from plant or vegetable origin is a clear, odorless and colorless oil which is also very stable to oxidation and supports high temperatures. Thanks to the physicochemical properties of squalane together with the appropriate vehicles according to the composition of the present invention, it is possible to obtain an emulsion suitable and permeable in the lipid surface of waxy fruits cuticles, as the case of pome fruits, when stored under cold conditions (between −0.5 y 1° C.) for prolonged periods, even 28 weeks (7 months) and a week at ambient temperature (20° C.). The lower the cuticle thickness, the better is composition effectiveness, as observed for the case of pears.

When compared with citric fruits, pome fruits such as apples, pears, quinces, medlars and loquats have an edible skin. The composition of the present invention allows the control of scald in said fruits in significant rates, without producing adverse effects when consumed by humans.

Regarding the quality of pome fruits object of application of the composition of the present invention, the application of squalane of plant origin causes neither deterioration nor alteration of maturity in fruits.

Having thus described the preferred embodiments of the invention with regard to the figures accompanying description, it will be understood that the invention is not limited to said preferred embodiments, and that any expert in the field could perform modifications, maintaining the core of the invention.

Provided below there are presented examples of realization of the invention, which have been included with the purpose of illustrating the invention, their preferred embodiments and comparative examples, but they should never be considered to restrict the scope of the patent application, which is only limited by the content of claims attached herein.

### EXAMPLES

### Example 1

### Effect of the Application of Squalene and Squalane of Animal Origin in Pome Fruits to Control Superficial Scald

According to the proposed invention, the selection of squalane of plant origin as an anti-scald active ingredient to control surface scald in pome fruits is not a trivial task and it is sustained according to the results showed below, where squalane from animal origin does not have anti-scalding activity in pome fruits.

A study was performed in which a composition whose active ingredient was squalene (Merck®, Germany) of animal origin (shark liver) or squalene obtained from hydrogenation of it (Merck®, Germany), according to Table 1 as follows.

TABLE 1
Formulations based on squalene and squalane of animal origin
(shark liver).

| | | Dose of use |
|---|---|---|
| Active ingredient | Formulation | in immersion |
| Squalene of | Squalene (Merck) 100% | 2% v/v dilution |
| animal origin | or | of the |
| | Squalene (Merck) 70% v/v | formulation in |
| | Polysorbate (2-[2-[3,4-bis(2- | water |
| | hydroxyethoxy) oxolan-2-yl]-2-(2- | |
| | hydroxyethoxy) ethoxy] ethyl (E)- | |
| | octadec-9-enoate) | |
| | 15% v/v | |
| | or | |
| | Squalene (Merck) 80% v/v | |
| | Sorbitan Monooleate ([2- | |
| | [(2R,3S,4R)-3,4-dihydroxyoxolan-2- | |
| | yl]-2-hydroxyethyl] | |
| | (Z)-octadec-9-enoate) 15% v/v | |
| Squalane of | Squalane (Merck) 100% | 2% v/v dilution |
| animal origin | | of the |
| | | formulation in |
| | | water |

The previous formulations were diluted in water according to Table 1 and then healthy Granny Smith apples were immersed in said diluted formulations during one minute, immediately after the fruit was harvested. One hundred apples were obtained from La Alborada Garden (VII Region, Chile) of season 2010/2011 and after application of formulations they were stored in conventional cold (without modification of atmospheric gases) between 0-1° C. and relative humidity between 85-90% during 120 and 180 days. Then, fruits were maintained at ambient temperature (20° C.) for 7 days. One hundred apples were used as a control and did not receive treatment but were subjected to the same temperature conditions previously mentioned. The statistical analysis was performed by an ANOVA test and Tukey (HSD) mean separation test. Different letters mean significant differences between groups, (n.s. not significant).

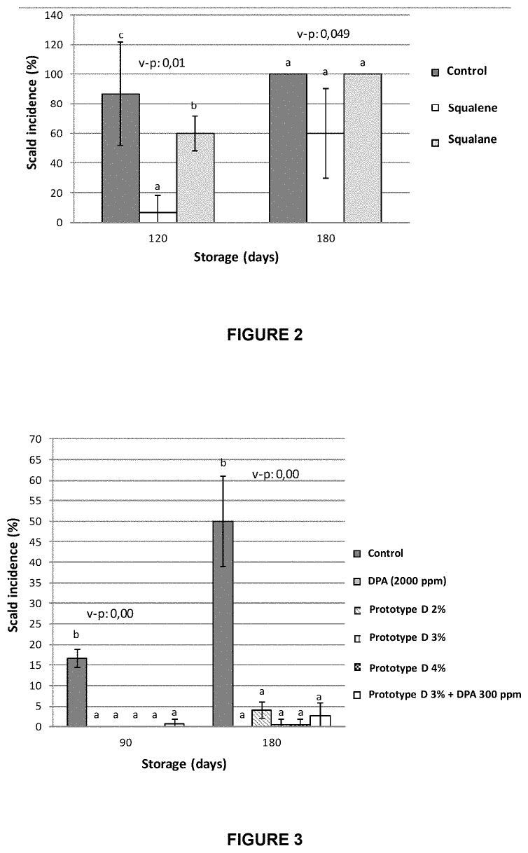

As pointed in FIG. 2, results showed that only after 120 days of storage in conventional cold and 7 days in ambient temperature (20° C.) storage, squalene of animal origin significantly reduced the incidence (number of sick fruits/number of total fruits) of surface scald in comparison with control apples, but not in the case of squalane of animal origin which produced a 60% of scalded fruits. Moreover, after 180 days of storage in cold conditions and 7 days at ambient temperature (20° C.) no significant differences were observed between treatments with squalene and squalane of animal origin and control group, wherein squalene of animal origin did not produce a significant anti-scalding effect. These results show that squalane of animal origin does not have anti-scalding activity in pome fruits, wherein 100% of fruits treated with said compound suffered surface scalding, just as the control group of untreated apples.

It is important to highlight that, even though squalene of animal origin reduces incidence in surface scalding after 120 days of storage (FIG. 2), current usage of this compound or squalane derivated from it of animal origin is not viable due to environmental reasons and marine fauna conservation which prohibits the use of sharks as raw material (Spanova, M., & Daum, G. (2011). Squalene-biochemistry, molecular biology, process biotechnology, and applications. European Journal of Lipid Science and Technology, 113(11), 1299-1320); and also, since it is obtained from the liver, highly toxic compounds and heavy metals may be present, which are harmful for health (McPhee, D. y cols. (2014). Squalane from Sugarcane. Cosmetics & Toiletries magazine, Vol. 129, No. 6), as previously mentioned in the state of the art.

### Example 2

### Use of Squalane of Plant Origin as Anti-Scalding Active Ingredient in Pome Fruits

A composition was prepared as an emulsion, whose active ingredient was squalane (Phytosqualane, Sophim, France) of plant origin, according to Table 2 below. Said composition was named “Prototype D”.

TABLE 2
Formulation of a composition based on squalane of plant origin.

| | | Dose of use |
|---|---|---|
| Active ingredient | Formulation | in immersion |
| Squalane of | squalane 70% v/v | 2, 3 and 4% |
| plant origin | oleic acid 20% v/v | dilution of the |
| | ammonium hydroxide (25%) 4% v/v | formulation in |
| | deionised water* | water |

*Formulation equivalent to prototype number 7 of Table 3 shown hereinafter.

The squalane used was obtained from hydrogenation of squalene from refining of olive oil (information available in www.sophim.com/en/phytosqualan-0). The effect of the composition in the different doses was assessed in apples and pears.

A number of 600 healthy Granny Smith apples were harvested from La Alborada Garden (VII Region, Chile) in season 2013/2014, and were treated by immersion in “Protoype D” composition in different doses diluted in water, and were stored for 90 and 180 days in conventional cold conditions between 0-1° C. and 85-90% of relative humidity, plus seven days of exposure at ambient temperature (20° C.). Untreated fruits were used as negative control, but were subjected to the same mentioned conditions of temperature. Diphenylamine was used as a positive control (DPA, 2.000 ppm) while a group was treated with “Prototype D” composition (squalane of plant origin, 3%) and DPA (300 ppm). Each group used an amount between 50 and 100 apples. Then, incidence of surface scald in fruits was assessed. The statistical analysis was performed by an ANOVA test and Tukey (HSD) mean separation test. Different letters mean significant differences between groups.

As shown in FIG. 3, all tested formulations whose active ingredient is squalane of plant origin reduced the incidence in surface scald in more than 98%, which was statistically significant in comparison with the fruits used as controls that were untreated.

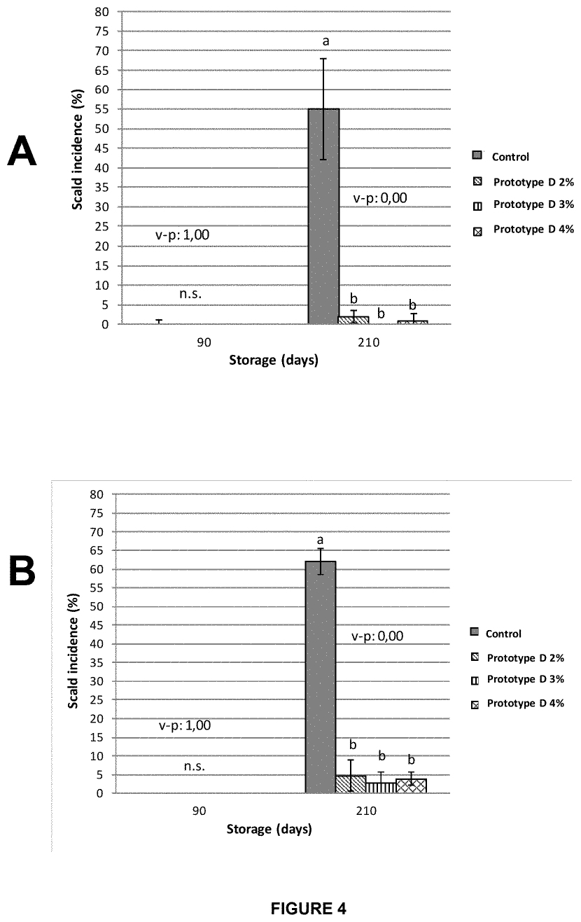

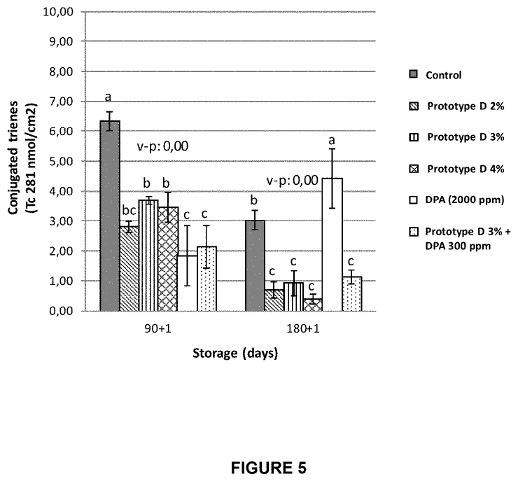

In parallel, the same previous experiment was repeated using Packham's Triumph pears from two commercial gardens from season 2013/2014. The fruits were superficially treated with “Prototype D” composition diluted in water at 2-4% v/v whose active ingredient is squalane of plant origin and then were stored during 90 and 120 days under conventional cold conditions at −0,5 ° C. and relative humidity between 85 and 90%, plus seven days of exposure to ambient temperature (20° C.). Untreated fruits were used as a negative control. The statistical analysis was performed by an ANOVA test and Tukey (HSD) mean separation test. Different letters mean significant differences between groups. Then, the incidence of superficial scald was assessed and it was found that all prototypes of squalane compositions (Phytosqualan, Sophim, Francia) of plant origin in concentrations between 2-4% v/v used decreased the incidence of surface scald in 95-98%, as shown in FIG. 4.

Considering the previous results it is clear that squalane of plant origin as active ingredient has an anti-scald activity which is effective to avoid the generation of undesirable dark spots that are produced when pome fruits are stored under cold conditions. Particularly, in the case of apples, tested formulations reduced the incidence of surface scald in more than 98% at 180 days (FIG. 3); while in the case of pears, compositions based on squalane of plant origin reduced scald incidence between 95-98% at 210 days (7 months) (FIG. 4).

### Example 3

### Compositions Comprising Squalane of Plant Origin as Anti-Scald Active Ingredient for Pome Fruits

Applications of oils in a pure form are not commercially viable since it is very toxic for fruits, causing damage in lenticels and necrosis after its use. Therefore, it is preferred to obtain a composition of squalane which also contains an appropriate vehicle to form an emulsion and, in this way, stabilize the active ingredient before its application to the surface of pome fruits.

Different compositions comprising squalane of plant origin as active ingredient were tested for anti-scald activity in pome fruits, and for this, different emulsifying, emulgent or surfactant stabilizing agents were analyzed to obtain an emulsion. The squalane used was obtained from hydrogenation of squalene from refinated olive oil (information available in www.sophim.com/en/phytosqualan-0).

Table 3 shows proportions of squalane of plant origin used and different emulsifying agents tested, highlighting those prototypes that were able to form an emulsion (7, 11, 13 y 22).

TABLE 3
Proportion (%) of emulsifying agent and active ingredient in different tested
prototypes.

| Emulsifying | | | | | | | | | | | | |
|---|---|---|---|---|---|---|---|---|---|---|---|---|
| agents and active | | | | | | | | | | | | |
| ingredient | 1 | 2 | 3 | 4 | 5 | 6 | 7 | 8 | 9 | 10 | 11 | 12 |
| Squalane of | 70 | 70 | 70 | 70 | 70 | 70 | 70 | 70 | 70 | 70 | 70 | 70 |
| plant origin | | | | | | | | | | | | |
| (Phytosqualan ®) | | | | | | | | | | | | |
| Polyoxyethylene | 15 | 5 | | | | | | | | | | |
| sorbitan | | | | | | | | | | | | |
| monooleate | | | | | | | | | | | | |
| (TWEEN ® 80) | | | | | | | | | | | | |
| Sorbitan | 15 | | 15 | | 15 | | | | | | | |
| monooleate | | | | | | | | | | | | |
| (SPAN ® 80) | | | | | | | | | | | | |
| Polyoxyethylene-sorbitan | | | 15 | | | | | | | | | |
| monostearate | | | | | | | | | | | | |
| (TWEEN ® 60) | | | | | | | | | | | | |
| Sorbitan | | 25 | | 15 | | | | | | | | |
| monolaurate | | | | | | | | | | | | |
| (SPAN ® 20) | | | | | | | | | | | | |
| Polyoxyethylene | | | | 15 | 15 | | | | | | | |
| sorbitan | | | | | | | | | | | | |
| monolaurate | | | | | | | | | | | | |
| (TWEEN ® 21) | | | | | | | | | | | | |
| Oleic acid | | | | | | 20 | 20 | | | | | 10 |
| Palm fatty acid | | | | | | | | | | 20 | 20 | |
| Myristic acid | | | | | | | | 20 | 20 | | | 10 |
| KOH | | | | | | 4 | | 5 | | 4 | | 5 |
| Ammonia | | | | | | | 4 | | 5 | | 4 | |
| Deionised water. | | | | | | 6 | 6 | 5 | 5 | 6 | 6 | 5 |
| Generation of an | NO | NO | NO | NO | NO | NO | YES | NO | NO | NO | YES | NO |
| emulsion | | | | | | | | | | | | |

Proportion (%) of emulsifying agents and active ingredient in
different prototypes tested.

| Emulsifying | | | | | | | | | | |
|---|---|---|---|---|---|---|---|---|---|---|
| agents and active | | | | | | | | | | |
| ingredient | 13 | 14 | 15 | 16 | 17 | 18 | 19 | 20 | 21 | 22 |
| Squalane of plant | 70 | 70 | 70 | 70 | 70 | 70 | 70 | 70 | 70 | 70 |
| origin | | | | | | | | | | |
| (Phytosqualan ®) | | | | | | | | | | |
| Ethoxylated | 30 | | | | | | | | | |
| alcohol | | | | | | | | | | |
| (Neodol ®) | | | | | | | | | | |
| Ethoxylated | | 30 | | 10 | | | | | | |
| alcohol (Rhenipal | | | | | | | | | | |
| 10) | | | | | | | | | | |
| Polyethylene | | | 30 | 20 | | | | | | |
| glycol | | | | | | | | | | |
| nonylphenyl | | | | | | | | | | |
| ether (Rhenipal | | | | | | | | | | |
| 6) | | | | | | | | | | |
| Polyoxyethylene | | | | | 20 | 15 | | | | |
| sorbitan | | | | | | | | | | |
| monooleate | | | | | | | | | | |
| (TWEEN ® 80) | | | | | | | | | | |
| Sorbitan | | | | | 10 | | 10 | | 5 | |
| monooleate | | | | | | | | | | |
| (SPAN ® 80) | | | | | | | | | | |
| Polyoxyethylene-sorbitan | | | | | | | 20 | | | |
| monostearate | | | | | | | | | | |
| (TWEEN ® 60) | | | | | | | | | | |
| Sorbitan | | | | | | 15 | | 10 | | |
| monolaurate | | | | | | | | | | |
| (SPAN ® 20) | | | | | | | | | | |
| Polyoxyethylene | | | | | | | | 20 | 25 | 30 |
| sorbitan | | | | | | | | | | |
| monolaurate | | | | | | | | | | |
| (TWEEN ® 21) | | | | | | | | | | |
| Generation of an | YES | NO | NO | NO | NO | NO | NO | NO | NO | YES |
| emulsion | | | | | | | | | | |

From Table 3 it is observed that it is not trivial to obtain an emulsion of squalane of plant origin, wherein the preferred emulsifiers are oleic acid, palm fatty acid, a surfactant primary alcohol such as Neodol® and sorbitan ester such as Tween®-21.

### Example 4

### Evaluation of Quality Parameters in Pome Fruits Treated with Emulsions of Squalane of Plant Origin

Among symptoms of surface scald in pome fruits there exist brownish or dark spots on fruit skin whose origin is attributed to oxidation of α-farnesene, natural compound present in the fruit, and produces reactive conjugated trienes. These compounds can even cause death of hypodermal plant cells in case of severe damage (Moggia, C., Moya-León, M. A., Pereira, M., Yuri, J. A., & Lobos, G. A. (2010). Effect of DPA [Diphenylamine] and 1-MCP [1-methylcyclopropene] on chemical compounds related to superficial scald of Granny Smith apples. Spanish Journal of Agricultural Research, 8(1), 178-187).

The concentration of conjugated trienes was estimated by means of spectrophotometry at different wavelengths. Measurement consisted in extracting fruit skin samples from a known area and submerging them in n-hexane for three minutes to then take an aliquot and Reading at different wavelengths in a spectrophotometer. Treatments consisted in application of an emulsion based on squalane of plant origin and oleic acid, diluted at 2-4% v/v in water (Prototype D or 7 in Table 3) and an untreated control group. Measurements were performed after 90 and 180 days of storage in conventional cold conditions (without modification of atmospheric gases) plus one day of exposure at ambient temperature (20° C.). Diphenylamine (DPA) was applied as positive control (2,000 ppm) and untreated apples were used as a negative control. One of the treatment groups consisted in the application of a mixture of DPA (300 ppm) and the emulsion based on squalane of plant origin diluted in water at 3% v/v. The statistical analysis was performed by an ANOVA test and Tukey (HSD) mean separation test. Different letters mean significant differences between groups.

According to the results shown in FIG. 5, application of the formulation based on squalane of plant origin in the present invention significantly reduced the accumulation of conjugated triene compounds at 90 and 180 days, being in this case significantly lower than diphenylamine.

Furthermore, in another trial during season 2013/2014, maturity parameters such as firmness of the flesh and skin color in apples and pears were measured. Firmness of fruit flesh was assessed with an automatic fruit texture analyzer (Model G-15, Guss) and skin color was measured with a colorimeter (Minolta, CR 20°, Japan). Evaluations were performed after the application through immersion of the fruits in an emulsion based on squalane of plant origin and oleic acid (Prototype D or 7 in Table 3) and storage for 90 and 210 days under conventional cold plus one or seven days at ambient temperature (20° C.). The statistical analysis was performed by an ANOVA test and Tukey (HSD) mean separation test. Different letters mean significant differences between groups.

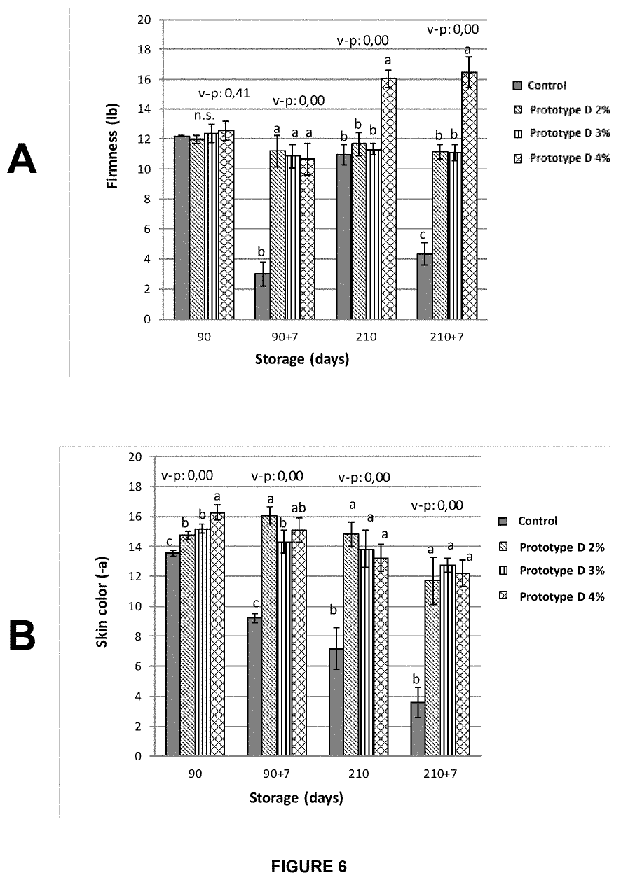

As shown in FIG. 6, application of the anti-scald emulsion based on squalane of plant origin in apples and pears showed positive effects in quality parameters of fruit, such as a higher firmness (A) and a lower degradation of skin color (B) when compared to untreated control fruits but subjected to the same mentioned conditions of temperature.

1. An anti-scald composition for pome fruits, comprising squalane of plant origin and an appropriate vehicle.

2. The composition of claim 1, wherein squalane of plant origin has a concentration range between 0.1-99.9% v/v.

3. The composition of claim 1, wherein squalane of plant origin is obtained from olive oil.

4. The composition of claim 3, wherein squalane of plant origin is hydrogenated squalene of olive oil.

5. The composition of claim 1, wherein the appropriate vehicle is an emulsifying agent.

6. The composition of claim 5, wherein the emulsifying agent is selected from the group consisting of: oleic acid, palm fatty acid, a sorbitan ester or a primary alcohol.

7. The composition of claim 6, wherein the emulsifying agent has a concentration between 0.1-99.9% v/v.

8. The composition of claim 1, additionally comprising ammonia in a concentration between 0.05-10% v/v.

9. The composition of claim 1, wherein pome fruits are apples and pears.

10. A method for controlling scald in pome fruits, comprising the following steps:
i) providing the anti-scald composition of claim 1, and
ii) contacting said composition with the surface of pome fruits.

11. The method of claim 10, wherein the contact between the composition and the surface of pome fruits is performed by means of immersion, nebulization or spray.

12. The method of claim 10, wherein the contact between the composition and the surface of pome fruits is performed during at least one second.

13. Use of squalane of plant origin, for the manufacture of an anti-scald composition for pome fruits.
